(19) United States
(12) Patent Application Publication
(10) Pub. No.: US 2013/0088574 A1
(43) Pub. Date: Apr. 11, 2013

(54) Detective Adjusting Apparatus for Stereoscopic Image and Related Method

(71) Applicants: Chao Hung Lu, Xiamen (CN); Sheng Yun Hsu, Xiamen (CN)

(72) Inventors: Chao Hung Lu, Xiamen (CN); Sheng Yun Hsu, Xiamen (CN)

(21) Appl. No.: 13/587,972

(22) Filed: Aug. 17, 2012

(30) Foreign Application Priority Data
Oct. 11, 2011 (CN) 201110307290.0

(51) Int. Cl. H04N 13/02; H04N 13/04

(52) U.S. Cl. 348/46; 348/E13.074; 348/E13.026

(57) ABSTRACT

A detective adjusting apparatus for a stereoscopic image and a related method is disclosed in the present invention. The apparatus includes an image capturing device, an image processing device, a stereoscopic display and an image analyzing/displaying device. The present invention utilizes the method to calculate an angle between eyes' position and a central position according to the face position, to determine the stereoscopic image by analyzing parameters of the stereoscopic image and the stereoscopic display, and to display the continuous stereoscopic image having at least two viewpoints, so the a viewer can watch the stereoscopic image clearly. The present invention is applied to an optical grating or an auto-stereoscopic screen made by lens.

### BACKGROUND OF THE INVENTION

1. Field of the Invention

The present invention relates to a stereoscopic displaying method, and more particularly, to a detective adjusting apparatus for a stereoscopic image and a related method.

2. Description of the Prior Art

As development of stereoscopic displaying technology, an interaction between the displaying content and a viewer is paid much attention. A conventional method is utilizing a camera to capture an image, finding out a position of the viewer's face by a sample matching method, and calculating a movement of the image according to the face position for switching the image content.

However, the conventional sample matching method has drawbacks of large error, low sensitivity and slow response. The conventional method for adjusting image's position is utilized to a two-viewpoint panel, and is not suitable to present panel technology, which results in an intermittent error when applying to a multi-viewpoint panel.

A stereoscopic displaying method, a tracking stereoscopic display and a method for an image processing device disclosed in CN application No. 201010229920.2 is applied to the two-viewpoint panel, the viewer watches the same image from different view angles.

### SUMMARY OF THE INVENTION

The present invention provides a detective adjusting apparatus and a related method. The present invention is applied to an optical grating or an auto-stereoscopic screen made by lens having two-viewpoint or multi-viewpoint functions, so as to generate a continuous stereoscopic image.

According to the claimed invention, a detective adjusting apparatus includes an image capturing device, an image processing device, a stereoscopic display and an image analyzing/displaying device. The image capturing device is for capturing an image. The image processing device is for processing the image provided from the image capturing device and for detecting a position of a face on the image according to a face characteristic. The stereoscopic display is for displaying a stereoscopic image. The image analyzing/displaying device is for calculating data of the image according to parameters of an angle of face position, the stereoscopic image and the stereoscopic display, and further for transmitting the data to the stereoscopic display. The image capturing device is electrically connected to the image processing device via a video cable. The image processing device is electrically connected to the image analyzing/displaying device via a datum cable. An input end and an out end of the image analyzing/displaying device are electrically connected to the two-viewpoint stereoscopic image and the stereoscopic display.

According to the claimed invention, the image capturing device is a single-image capturing device or a two-viewpoint image capturing device.

According to the claimed invention, the stereoscopic display includes an optical grating or an auto-stereoscopic screen made by lens.

According to the claimed invention, a method of executing a detective adjusting apparatus is disclosed. The method includes an image processing device analyzing an image provided from an image capturing device to find to a position of eyes according to a face recognition algorithm, the image processing device calculating an angle between positions of the eyes according to the position of the eyes and a central point of a stereoscopic display, an image analyzing/displaying device setting parameters of an stereoscopic image and the stereoscopic display, and the image analyzing/displaying device analyzing the parameters of the angle between the positions of the eyes, the stereoscopic image and the stereoscopic display, so as to adjust content of the image according to a variation of the face's position for outputting the successive stereoscopic image. The stereoscopic image parameter comprises an amount of the image's viewpoint, the stereoscopic display parameter comprises an amount of the stereoscopic display's viewpoint and a pixel mapping table.

According to the claimed invention, the face recognition algorithm comprises an adaboost algorithm, an ANN algorithm and a SVM algorithm.

According to the claimed invention, the pixel mapping table is not modified by the image analyzing/displaying device, the image analyzing/displaying device re-allots pixels to switch the stereoscopic image.

The present invention utilizes the above-mentioned method to calculate an angle between eyes' position and a central position according to the face position, to determine a stereoscopic image by analyzing parameters of the stereoscopic image and the stereoscopic display, and to display the continuous stereoscopic image having at least two viewpoints, so the a viewer can watch the stereoscopic image clearly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a detective adjusting apparatus according to an embodiment of the present invention.

### DETAILED DESCRIPTION OF THE INVENTION

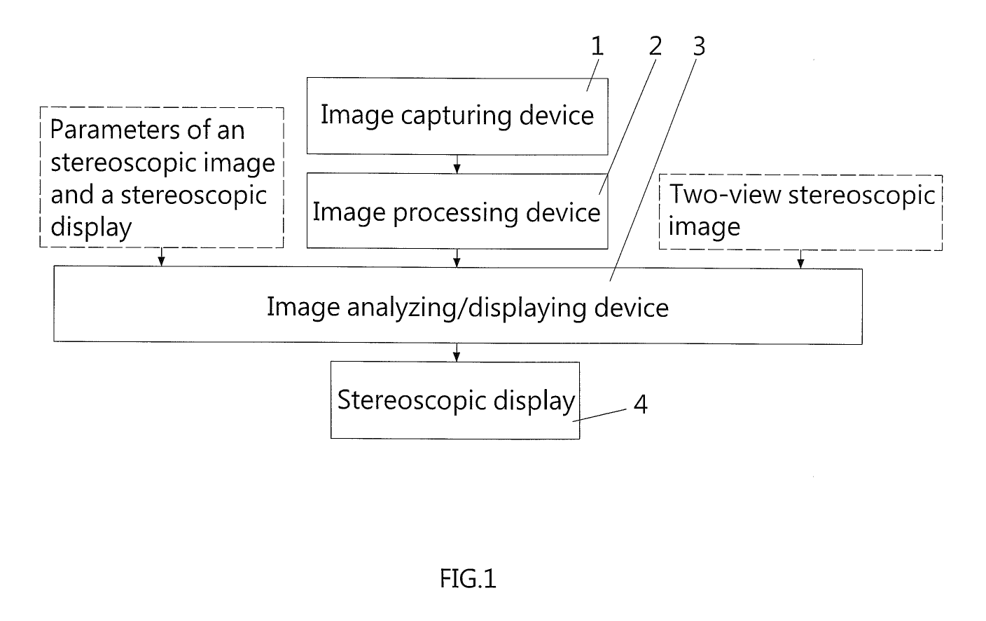

As shown in FIG. 1, the present invention includes an image capturing device 1, an image processing device 2, an image analyzing/displaying device 3 and a stereoscopic display 4. The image capturing device 1 is for capturing an image. The image processing device 2 is for processing the image provided from the image capturing device 1 and for detecting a position of a face on the image according to a face characteristic. The stereoscopic display 4 is for displaying a stereoscopic image. The image analyzing/displaying device 3 is for calculating data of the image according to parameters of an angle of face position, the stereoscopic image and the stereoscopic display, and further for transmitting the data to the stereoscopic display 4.

The image capturing device 1 is electrically connected to the image processing device 2 via a video cable. The image processing device 2 is electrically connected to the image analyzing/displaying device 3 via a datum cable. An input end and an out end of the image analyzing/displaying device 3 are electrically connected to the two-viewpoint stereoscopic image(or a two-view image or a two view-angle image) and the stereoscopic display 4.

The image processing device 2 utilizes an adaboost algorithm to find out positions of human eyes by the image provided from the image capturing device 1, and further calculates an angle θ₁ between the eye's position and a central position of the stereoscopic display 4.

The image analyzing/displaying device 3 sets two parameters. One is a stereoscopic image parameter P₁ the stereoscopic image parameter P₁ includes an amount of the image's viewpoint. The other is a stereoscopic display parameter. The stereoscopic display parameter includes basic information of the stereoscopic display 4, such as a viewpoint amount P₂ of the stereoscopic display and a pixel mapping P₃. The pixel mapping P₃ includes data of pixel's view angle.

Calculation of the image analyzing/displaying device 3 by the parameters of the stereoscopic image and the stereoscopic display includes following steps.

Step 1: P₁=2, P₂=2.

P₁=2 indicates that an amount of the image's viewpoint equals two. No matter what position the viewer stands, the viewer can watch the same image. P₂=2 indicates that the stereoscopic image is a 2-view image, which includes a left view angle and a right view angle. In the above-mentioned condition, the image analyzing/displaying device 3 can obtain a value A₁ by multiplying the angle θ₁ by a weight. The angle θ₁ is provided from the image processing device 2. As the value A₁ is even, the left view angle image of the two-view image can be transmitted to a left view angle image position according to the pixel mapping P₃, and the right view angle image of the two-view image can be transmitted to a right view angle image position according to the pixel mapping P₃. As the value A₁ is odd, the left view angle image of the two-view image can be transmitted to the right view angle image position according to the pixel mapping P₃, and the right view angle image of the two-view image can be transmitted to the left view angle image position according to the pixel mapping P₃.

Step 2: P₁>2, P₂=2.

P₁>2 indicates that the amount of the image's viewpoint is greater than two. The viewer can watch different images at different positions, and an amount of the image's viewpoint is P₁. Each image is Nₓ, 1≦X≦P₁, and X is an integer. P₂=2 indicates that the stereoscopic image is the 2-view image, which includes the left view and the right view. In the above-mentioned condition, the image analyzing/displaying device 3 can obtain a value A₂ by multiplying the angle θ₁ by a weight. The angle θ₁ is provided from the image processing device 2. A view angle θ₂ of the stereoscopic image divided by (P₁−1) equals a value θ₃. The value θ₃ indicates two continuous images (N_{X-1}, N_{X}), such as (N₁, N₂), and an interval between the two continuous images is the value θ₃. Across the value θ₃ to the value θ₃+1, the image is switched to next image (N_{X-1+1}, N_{X+1}), such as (N₁, N₂) between zero and the value θ₃. When the view angle equals the angle θ₃+1, the image can be switched to (N₁₊₁, N₂₊₁). According to the angle θ₃, as the value A₂ is even, the left view angle image N_{X-1} of the two-view image can be transmitted to the left view angle image position according to the pixel mapping P₃, and the right view angle image N_{X} of the two-view image can be transmitted to the right view angle image position according to the pixel mapping P₃. As the value A₂ is odd, the left view angle image N_{X-1} of the two-view image can be transmitted to the right view angle image position according to the pixel mapping P₃, and the right view angle image N_{X} of the two-view image can be transmitted to the left view angle image position according to the pixel mapping P₃.

Step 3: P₁=2, P₂>2.

P₁=2 indicates that the amount of image's viewpoint equals two. No matter what position the viewer stands, the viewer can watch the same image. P₂>2 indicates that an amount of viewpoint of the stereoscopic image is P₂, which is greater than two. All even view angle can be set as the same image, and all odd view angle can be set as the same image. In the above-mentioned condition, the image analyzing/displaying device 3 can obtain a value A₃ by multiplying the angle θ₁ by a weight. The angle θ₁ is provided from the image processing device 2. As the value A₃ is even, the left view angle image of the two-view image can be transmitted to an odd view angle image position according to the pixel mapping P₃, and the right view angle image of the two-view image can be transmitted to an even view angle image position according to the pixel mapping P₃. As the value A₃ is odd, the left view angle image of the two-view image can be transmitted to the even view angle image position according to the pixel mapping P₃, and the right view angle image of the two-view image can be transmitted to the odd view angle image position according to the pixel mapping P₃.

Step 4: P₁>2, P₂>2.

P₁>2 indicates that the amount of image's viewpoint is greater than two. The viewer can watch different images at different positions, and an amount of image's viewpoint is P₁. Each image is Nₓ, 1≦X≦P₁, and X is an integer. P₂>2 indicates that that an amount of viewpoint of the stereoscopic image is P₂, which is greater than two. All even view angle can be set as the same image, and all odd view angle can be set as the same image. In the above-mentioned condition, the image analyzing/displaying device 3 can obtain a value A₄ by multiplying the angle θ₁ by a weight. The angle θ₁ is provided from the image processing device 2. A view angle θ₂ of the stereoscopic image divided by (P₁−1) equals a value θ₃. The value θ₃ indicates two continuous images (N_{X-1}, N_{X}), such as (N₁, N₂), and an interval between the two continuous images is the value θ₃. Across the value θ₃ to the value θ₃+1, the image is switched to next image (N_{X-1+1}, N_{X+1}), such as (N₁, N₂) between zero and the value θ₃. When the viewpoint equals the angle θ₃+1, the image can be switched to (N₁₊₁, N₂₊₁). According to the angle θ₃, as the value A₄ is even, the left view angle image N_{X-1} of the two-view image can be transmitted to the odd view angle image position according to the pixel mapping P₃, and the right view angle image N_{X} of the two-view image can be transmitted to the even view angle image position according to the pixel mapping P₃. As the value A₄ is odd, the left view angle image N_{X-1} of the two-view image can be transmitted to the even view angle image position according to the pixel mapping P₃, and the right view angle image N_{X} of the two-view image can be transmitted to the odd view angle image position according to the pixel mapping P₃.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A detective adjusting apparatus for a stereoscopic image, the detective adjusting apparatus comprising:
an image capturing device for capturing an image;
an image processing device for processing the image provided from the image capturing device and for detecting a position of a face on the image according to a face characteristic;
a stereoscopic display for displaying the stereoscopic image; and
an image analyzing/displaying device for calculating data of the image according to parameters of an angle of face position, the stereoscopic image and the stereoscopic display and for transmitting the data to the stereoscopic display;
wherein the image capturing device is electrically connected to the image processing device via a video cable, the image processing device is electrically connected to the image analyzing/displaying device via a datum cable, an input end and an out end of the image analyzing/displaying device are electrically connected to the two-viewpoint stereoscopic image and the stereoscopic display.

2. The detective adjusting apparatus of claim 1, wherein the image capturing device is a single-image capturing device or a two-viewpoint image capturing device.

3. The detective adjusting apparatus of claim 1, wherein the stereoscopic display includes an optical grating or an auto-stereoscopic screen made by lens.

4. A method of executing a detective adjusting apparatus, the method comprising:
an image processing device analyzing an image provided from an image capturing device to find to a position of eyes according to a face recognition algorithm;
the image processing device calculating an angle between positions of the eyes according to the position of the eyes and a central point of a stereoscopic display;
an image analyzing/displaying device setting parameters of an stereoscopic image and the stereoscopic display, wherein the stereoscopic image parameter comprises an amount of the image's viewpoint, the stereoscopic display parameter comprises an amount of the stereoscopic display's viewpoint and a pixel mapping table; and
the image analyzing/displaying device analyzing the parameters of the angle between the positions of the eyes, the stereoscopic image and the stereoscopic display, so as to adjust content of the image according to a variation of the face's position for outputting the successive stereoscopic image.

5. The method of claim 4, wherein the face recognition algorithm comprises an adaboost algorithm, an ANN algorithm and a SVM algorithm.

6. The method of claim 4, wherein the amount of the stereoscopic display's viewpoint comprises at least two viewpoints.

7. The method of claim 4, wherein the pixel mapping table is not modified by the image analyzing/displaying device, the image analyzing/displaying device re-allots pixels to switch the stereoscopic image.
